(19) United States
(12) Patent Application Publication
(10) Pub. No.: US 2012/0186453 A1
(43) Pub. Date: Jul. 26, 2012

(54) Marine Fuel Fume or Vapor Filter

(76) Inventor: Robert Gordon, San Diego, CA (US)

(21) Appl. No.: 13/356,490

(22) Filed: Jan. 23, 2012

Related U.S. Application Data
(60) Provisional application No. 61/435,275, filed on Jan. 22, 2011.

(51) Int. Cl. B01D 53/02

(52) U.S. Cl. 96/151; 96/108

(57) ABSTRACT

The present disclosure relates to a gas, diesel or other similar liquid fume or vapor filter apparatus specifically design to be utilized in the marine environment e.g. motorized boats. The fume or vapor filter apparatus includes a housing with an input and output coupling mechanism designed to engage the input and output vent line.

### RELATED APPLICATIONS

This application is a Non-Provisional U.S. Patent Application of Provisional patent application Ser. No. 61/435,275 filed on Jan. 1, 2011. This Application is incorporated herein by this reference.

### FIELD OF THE INVENTION

This present invention relates to fluid fume or vapor filters, and more particularly, to a fuel fume or vapor filter preferably for use in marine applications having an active scrubbing means.

### BACKGROUND OF THE INVENTION

Nearly all current marine boats and machinery utilize gasoline, diesel, or a similar fluid, that emits toxic and hazardous fumes to the environment. The emission of gasoline or similar fluid fumes over time reduces the amount of fuel available for power generation.

Typical marine fuel systems include tank-mounted lines and valves for venting pressurized or displaced fuel vapor from the vapor space in a fuel tank to a vapor exhaust port located outside of the fuel tank. The exhaust port is designed to remove entrained fuel vapors that are displaced and generated in the fuel tank during a typical marine refueling operation or that are otherwise vented from the fuel tank. The vapor line and exhaust port connected to a gas tank to vent fumes from collecting in the gas/diesel tank also minimize flammable and explosive events. Currently, there are no filters installed within the vapor line and all gas and similar fluids on marine boats are vented unabated out into the environment. This allows toxic and hazardous fumes to be emitted and wastes gas resources. And while the amount of emitted gasoline or diesel vapors seems minimal, with many hundreds or thousands of hours of unabated venting, the amount of fuel emission can add up and become significant.

Typical marine gas, diesel or similar fluid venting also offer a variety of devices to minimize water from entering and contaminating the gas or diesel storage tank. Fresh and salt water that contaminates a gas, diesel or other similar liquid tank can cause performance problems with the gas, diesel engines or motors.

Most marine boats have a typical sized vapor line with a outside diameter of ⅝″ so a universal fluid fume filter can be designed that easily can be installed in a marine boat to minimize the emission of gas or similar fluids vapors.

### SUMMARY OF THE INVENTION

The present disclosure relates to a gas, diesel or other similar liquid fume or vapor filter apparatus specifically design to be utilized in the marine environment e.g. motorized boats. The fume or vapor filter apparatus includes a housing with an input and output coupling mechanism designed to engage the input and output vent line and a one-way valve. The fume or vapor filter apparatus includes an active scrubbing means. The active scrubbing means is perishable and hence the filter will need to be changed periodically for maximum scrubbing efficiency. Alternately, the housing can be designed to include a opening mechanism and a removable active scrubbing means so that the active scrubbing means can be replace with a new fresh active scrubbing means without removing and destroying the present invention housing from the vent line. The active scrubbing means comprises primarily activated charcoal but can include other similar scrubbing materials.

The housing can be mounted in a vertical and upright position and include a rejection means to prevent water from entering the output vent from entering the vent line and ultimately the gas, diesel or similar storage tank. Alternately, the housing can be designed to be mounted in any particular angled configuration and a special water collection means will be included.

One of the objects of the present invention is to minimize fuel or vapor pollution emitting from unfiltered marine vent lines.

Another object of the present invention is to minimize the loss of fuel from marine boats and vessels that occurs due to the evaporation of fuel through typical vent lines.

### BRIEF DESCRIPTION OF THE DRAWINGS

FIG. 1 is a perspective view a typical motorized boat with an out board motor and fuel system with an operator using a deck mounted fueling station to deliver fuel to the fuel system.

FIG. 2 is a sectional view of the fuel system of a typical motorized boat showing the fuel delivery plumbing, a fuel storage tank, and a fuel vent line.

FIG. 3 is a sectional view of the fuel system of a typical motorized boat having the present invention installed within the fuel vent line.

FIG. 4 is a sectional view of the present invention showing the input and output couplers, the fuel vapor canister with fuel activation scrubbing means, and a one-way valve located in close proximity to the input coupler.

FIG. 5 is data plotted on a graph obtained from an experiment showing actual gas evaporation rates.

### DESCRIPTION OF THE PREFERRED EMBODIEMENTS

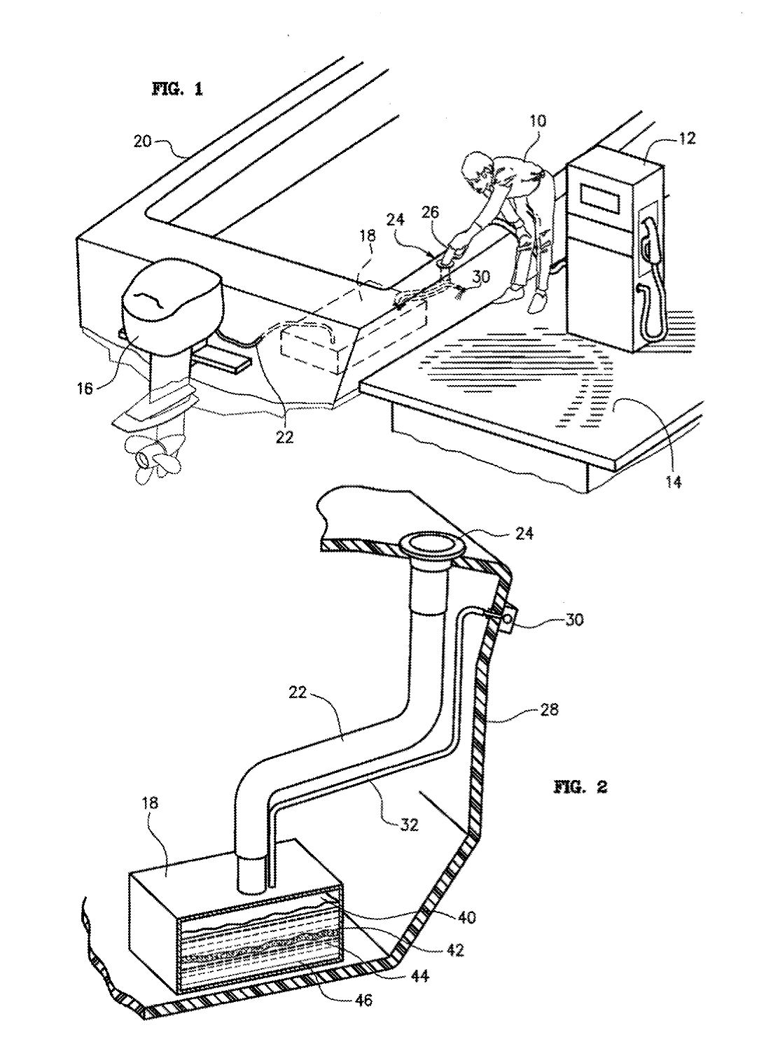

Now referring to FIG. 1, which shows a perspective view a typical motorized boat 20 with an out board motor 16 and tank filler means 24 with an operator 10 using a deck mounted fueling station 12 to deliver fuel to the fuel system. Also shown is a typical fuel storage tank 18 with a fuel vent output 30.

FIG. 2 shows a sectional view of the fuel system of a typical motorized boat showing the fuel delivery plumbing 22, a fuel storage tank 18, and a fuel vent line 32, the fuel vent output 30. The shell of the typical boat is shown a 28. Generally, when fuel e.g. gas, is stored in a tank for a given period of time with no disruption, its components tend to separate into several layers. As shown in the storage tank 18, the top layer 42 is generally the fuel component with the highest vapor pressure and is exposed to the empty air space 40 in the storage tank 18. The air space 40 is in pneumatic communication with the vent line 32 and vent output 30. The second layer 44 is generally the fuel component with a lower vapor pressure. The bottom layer is generally water that has coalesced from the environment and because it is heavier than fuel (per equal volume), it sinks to the bottom of the fuel storage tank 18.

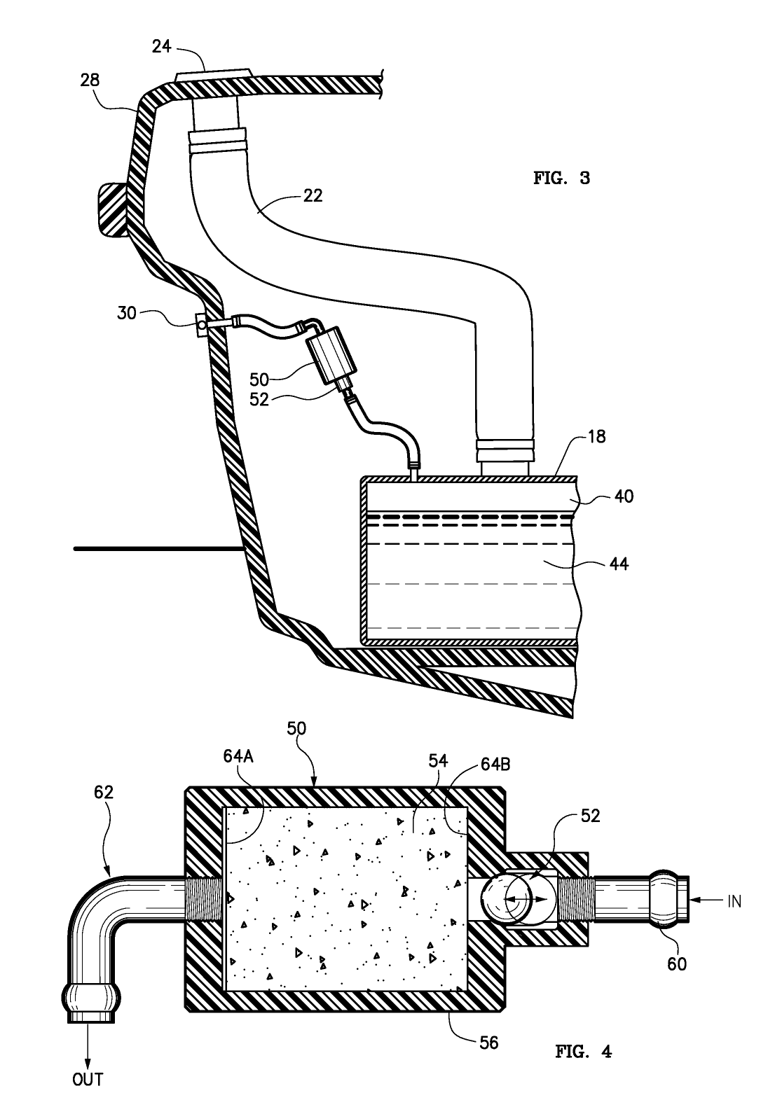

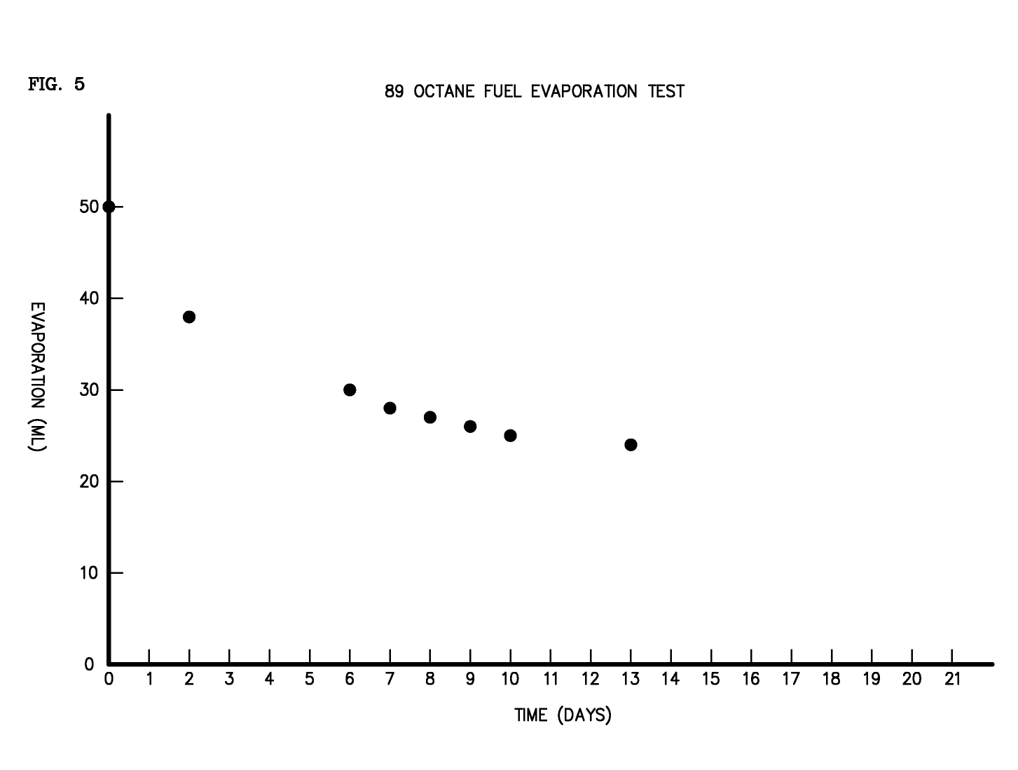

In referring to FIGS. 3 and 4, it is shown that the present disclosure relates to a gas, diesel or other similar liquid fume or vapor filter apparatus 50 specifically design to be utilized in the marine environment e.g. motorized boats. The fume or vapor filter apparatus 50 includes a canister housing 56 with an input 60 and output 62 coupling mechanism designed to engage the input and output of the vent line. The fume or vapor filter apparatus 50 includes an active scrubbing means 54. The active scrubbing means 54 comprises primarily of activated charcoal, coconut shell carbon, anthracite carbon, a combination of these scrubbing means, or can include other similar scrubbing materials. Activated carbon, also called activated charcoal or activated coal, is a form of carbon that has been processed to make it extremely porous and thus to have a very large surface area available for adsorption or chemical reactions. The word activated in the name is sometimes substituted by active. Due to its high degree of micro-porosity, just one gram of activated carbon has a surface area in excess of 500 m² (or about 2 tennis courts), as determined typically by nitrogen gas adsorption. Sufficient activation for useful applications may come solely from the high surface area, though further chemical treatment often enhances the adsorbing properties of the material. Activated carbon is usually derived from charcoal. Properties of activated carbon include:
Has a capacity for virtually any vapor contaminant; it will adsorb “some of almost any vapor”.
Has a large capacity for organic molecules, especially solvents.
Will adsorb and retain a wide variety of chemicals at the same time.
Has an extremely large capacity to catalytically destroy ozone, a major component of smog.
Works well under a wide range of temperature and humidity conditions.
Adsorbs odors and chemicals preferentially to moisture. It is not a desiccant and will release moisture to adsorb chemicals.
Can be used as a carrier of one material to attract and hold or react with another material.
Is inert and safe to handle and use.

Coconut shell carbon's superior level of hardness makes them cleaner than most other carbons and gives them longer life expectancy. This, combined with their high activity level, makes them well suited for use in any kind of carbon filter or system. Aside from general air purification and deodorization, our coconut shell carbons are also very, effective in solvent recovery applications.

Acid Washed Granular Coconut Shell Activated Carbon, like its name, comes from the coconut shell that has been undergone steam activation process to create its activated carbon form. During activation, it creates millions of pores at the surface of the carbon thus increasing the total surface area. Activated carbon pores can be divided into three general sizes:
Micro-pores (diameter in the range of less than 2 nm)
Meso-pores (diameter in the range of 2-25 nm)
Macro-pores (diameter in the range of above 25 nm)

Coconut shell carbon has mainly micro-pores to meso-pores, and due to its unique distribution of pores diameter, coconut shell activated carbon are very popular in the gas phase purification and potable water purification industries.

Anthracite is a hard, compact variety of mineral coal that has a high lustre. It has the highest carbon count and contains the fewest impurities of all coals, despite its lower calorific content. Anthracite is the highest of the metamorphic rank, in which the carbon content is between 92% and 98%. The term is applied to those varieties of coal which do not give off tarry or other hydrocarbon vapors when heated below their point of ignition. Anthracite ignites with difficulty and burns with a short, blue, and smokeless flame. Anthracite carbon is best for exhaust fumes, burning wood or petrochemicals.

The active scrubbing means 54 is perishable and hence the filter will need to be changed periodically for maximum scrubbing efficiency. The present invention can include a signal means (not shown) that displays a indicator or warning sign that the active scrubbing means 54 is no longer effective and needs to be replaced. The signal means can be attached to the canister housing 56 or could be in a remote location.

As shown in FIG. 3, the housing 56 can be mounted in a substantially vertical and upright position and include a rejection means to prevent water from entering the output vent from entering the vent line and ultimately the gas, diesel or similar storage tank. Within the filter housing, the filter element is arranged such that a water collecting chamber is formed at the bottom area. The active filter means can also include a coalescing element. The coalescing element has a hydrophilic means which finely water droplets within the fuel fumes or vapor are coalesced into larger drops. These larger drops subsequently sink toward the water collecting chamber at the bottom of the housing.

Alternately, the housing can be designed to mount in any particular angled configuration and a special water collection means will be included. In this embodiment, the active filter means can also include a coalescing element. The active filter means is arranged that are preferably made of plastic material which holds the active charcoal. The coalescing element has a hydrophilic means which finely water droplets within the fuel fumes or vapor are coalesced into larger drops. These larger drops subsequently sink toward the water collecting chamber at the side of the housing.

Now referring to FIG. 4, the present invention 50 with the canister housing 56, the input coupler 60 and the output coupler 62. The canister housing 56 is preferably made of polymer material, such as PEEK (polyetheretherketone), Nylon, Dacron, synthetic polyamide, polypropylene, expanded polytetrafluroethylene (e-PTFE), polyethylene and ultra-high molecular weight fibers of polyethylene (UHMWPE) commercially available as Spectra™ or Dyneema™, as well as other high tensile strength materials such as Vectran™, Kevlar™, or a metallic material, such as stainless steel, elgiloy, Nitinol, or other similar metals, which holds the scrubbing means 54.

The canister housing 56 is shown with a cylindrical shape, but it is anticipated by the Applicant can have various shapes, such as, but not limited to, circular, rectangle, or square. Incorporated near the input coupler 60 is a check valve or one way ball valve means 52 that functions to allow fumes and vapors to pass into the scrubbing means 54 but will not allow fluid liquid (e.g. gasoline or diesel) from entering and corrupting the scrubbing means 54. It is anticipated that a pair of screening means 64a located at the output end and screening means 64b located at the input end of the housing. It is also anticipated that the check valve or one way ball valve means 52 can extend a certain distance from the housing or can be located remotely from the housing to eliminate or minimize contamination of the scrubbing means 54 by exposure to liquid gas or diesel entering from the boat storage tank.

The present invention housing 54 with scrubbing means 54 is preferably designed to be removed and properly disposed when exhausted and no longer effective. Then replaced with a new present invention housing 54 with a fresh scrubbing means 54. Alternately, the canister housing 56 can be designed to include a opening mechanism and a removable active scrubbing means so that the active scrubbing means 54 (not shown) that can be replace with a new fresh active scrubbing means 54 without removing or disposing the present invention canister housing 54 from the vent line 32. The active scrubbing means 54 can be incorporated with a removable canister or cartridge.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure as come within known or customary practice and the art to which this invention pertains and which fall within the limits of the appended claims.

1. A marine fuel fume or vapor filter designed to be engaged with a boat venting line comprising;
a housing, said housing having a input and an output section;
said input section having a inlet connecting means and said output section having an outlet connecting means;
said inlet connecting mean designed to engage the inlet of a motorized boat venting line, said outlet connecting means designed to engage the outlet of a motorized boat venting line;
within said housing incorporating an active scrubbing means; and
said input section of the housing including a check valve means.

2. A marine fuel fume or vapor filter as recited in claim 1, wherein said active scrubbing means consists of activated charcoal, coal coconut charcoal, anthracite, or a combination of each of these materials.

3. A marine fuel fume or vapor filter as recited in claim 1, wherein said housing is comprised of a polymer material.

4. A marine fuel fume or vapor filter as recited in claim 1, wherein said housing is comprised of a metallic material.

5. A marine fuel fume or vapor filter as recited in claim 1, wherein said filter is designed to be properly disposed of when the active scrubbing means is no longer effective.

6. A marine fuel fume or vapor filter as recited in claim 1, further comprising a replacement means to replace the an ineffective scrubbing means with a fresh active scrubbing means.
